(19) United States
(12) Patent Application Publication
(10) Pub. No.: US 2026/0094180 A1
(43) Pub. Date: Apr. 2, 2026

(54) SYSTEM AND METHOD FOR DIGITAL CURRENCY PAYMENT REWARD ALLOCATION AND DELIVERY

(71) Applicants: Tomaz Kregar, Ljubljana (SI); Igor Kregar, Ljubljana (SI); Joshua Tate, Atlantis, FL (US); William C. Erbey, Christiansted (VI)

(72) Inventors: Tomaz Kregar, Ljubljana (SI); Igor Kregar, Ljubljana (SI); Joshua Tate, Atlantis, FL (US); William C. Erbey, Christiansted (VI)

(21) Appl. No.: 18/904,843

(22) Filed: Oct. 2, 2024

(51) Int. Cl. G06Q 30/0226; G06Q 20/06; G06Q 20/36

(52) U.S. Cl. CPC G06Q 30/0226; G06Q 20/065; G06Q 20/36; G06Q 2220/00

(57) ABSTRACT

The present disclosure relates to a method for digital currency payment reward allocation and delivery. The method includes receiving, at a payment processing system, a payment processing transaction (PPT) request using a cryptocurrency payment from a consumer. The payment processing system determines that the request qualifies for the delivery of a cryptocurrency reward. The payment processing system confirms that the cryptocurrency payment is recorded in a distributed ledger. The payment processing system issues the cryptocurrency reward to a consumer based on the PPT request.

### FIELD OF THE INVENTION

The present invention relates to the field of digital currency payment processing and reward platforms. In particular, the present invention relates to cryptocurrency payment processing and reward platforms having application programming interfaces and processing modules that provide the capability to allocate and deliver digital currency rewards to users in connection with processing payments.

### BACKGROUND OF THE INVENTION

Cryptocurrency is a digital currency (or virtual currency), often referred to as coins or tokens. The currency is secured by cryptography and through the use of decentralized networks based on blockchain technology. The use of cryptography and decentralized networks in cryptocurrencies allows transactions involving these digital currencies to be secure, pseudonymous, and what is often referred to as “trustless.” In other words, cryptocurrency transactions do not require a trusted third party, such as a bank, to facilitate the transactions. Instead, cryptocurrency transactions, such as those involving Bitcoin, rely on public and private key encryption on the decentralized blockchain network. Each user has a private key that is linked to a public key. The keys are cryptographically linked to ensure the veracity and authenticity of all transactions occurring on the blockchain. The link between the public and private keys allows the blockchain network to identify the correct user. One of the trustless aspects of cryptocurrency transactions is that they are generally considered to be irreversible. This inherent safety feature is designed to prevent fraud, such as through double spending.

Cryptocurrency transactions occur on the blockchain network, a massive, public, decentralized ledger that tracks every transaction. Each record or “block” on the blockchain is linked and secured using cryptographic methods through hash values and public-private key encryption. These hash values act as virtual date stamps for each transaction that occurs and are verified by subsequent blocks on the blockchain to ensure accuracy.

Once a block is recorded, the transaction and data are permanent. The date stamp on each block ensures that the transaction data existed when the block was published. Because the blocks each contain information about the block before it, they thus create a chain. Each additional block strengthens the chain by reinforcing all the blocks that come before it. The cryptocurrency transactions are recorded on the block by blockchain miners or validators who verify and validate each transaction's legitimacy before adding them to the blockchain, ensuring the network's integrity and security. These blockchain miners or validators are rewarded with transaction fees and/or network fees paid by the users initiating the cryptocurrency transaction. Transaction fees include charges paid to blockchain miners or validators for processing individual transactions, and are determined by the computational effort required and current network demand. Network fees encompass a variety of costs associated with utilizing the blockchain network, including transaction fees and additional charges for services like smart contract deployment and token swaps.

There are thousands of cryptocurrencies in existence. As cryptocurrencies have grown in popularity, their use in everyday commercial transactions and retail operations have increased. The increase in popularity and use of cryptocurrency in commercial transactions has given rise to unique challenges, not encountered in commercial transactions involving fiat currency, that arise out of the inherent differences between fiat and cryptocurrency, including the decentralized nature of cryptocurrency. The unique challenges include issues relating to control, volatility, finality, and exchange-rate-disparity—including extreme volatility in exchange rates as well as complicated conversions between fiat and cryptocurrencies. These challenges also include the payor or consumer sending incorrect payment amounts (by virtue of issues relating to volatility, user error, or other causes). An additional challenge involves verifying an address provided by a user for receiving cryptocurrency from another user or company, which is important because once cryptocurrency is sent to an address it cannot be recalled or retrieved without working with the owner of the address to send the cryptocurrency back to the sender. Often times these challenges can result in the need for a payor to submit more than one payment in order to complete a transaction, potentially from more than one source. Fluctuations in the value of cryptocurrencies can also interfere with accurate and timely allocation of funds for various incentives, such as rewards programs.

At the same time, the increase in the availability of cryptocurrency for use in commercial transactions gives payment processors the opportunity to encourage the use of their services through rewards. Such rewards can be used to encourage spending using cryptocurrency in general (or specific types of cryptocurrencies) as well as to establish customer loyalty and merchant relationships. However, the unique challenges encountered in commercial transactions involving cryptocurrency prevent the use of rewards programs with systems primarily designed for fiat transactions. As noted above, the challenges unique to cryptocurrency can result in multiple payments being submitted in connection with a transaction, potentially from more than one source, such that it may not be possible to determine the proper account or digital wallet to receive rewards. In other cases, the source of digital currency funds may not be readily identifiable from a payment transaction, or what is identified as the source of the digital currency funds may not be the appropriate location for receiving funds. This differs from conventional payment methods, such as via credit card payments, where only a single payment for a single amount is provided, and usually from a single account (e.g., an account with a bank debit card or credit card processing entity) that is readily identifiable and that can serve as both the source of funds and the recipient of funds (e.g., such as refunds or credits).

In addition, existing reward or loyalty programs typically require that a consumer set up a separate account in order to take advantage of such programs. The need for the consumer to set up a separate account to receive rewards or loyalty “points” can serve as a barrier and may dissuade a consumer from joining such programs. For example, such programs often require that the consumer link the account to one or more forms of payment or bank accounts, or that the consumer provide identifying information. Providing such financial information or personal information increases the risk of exposure of such information, such as through inadvertent disclosures of such information by program administrators, or by the use of such information by program administrators for other purposes (for example, re-selling of consumer financial information, either individually or in the aggregate) either with or without the explicit knowledge of the consumer. The potential risk to the consumer that such information is disclosed or used for other purposes can further dissuade a consumer from joining such programs, especially a consumer that may be inclined to use digital currency or cryptocurrency as a means for payment for purposes of avoiding the risk of inadvertent disclosure of financial information or personal information.

Additionally, transaction and network fees specific to digital currency transactions can present unique challenges to implementing rewards programs based on cryptocurrency. In some cases, sending tokens on a blockchain network may require a different currency than the tokens being transferred. For example, in order to transfer Ethereum tokens, like ERC-20 tokens, on the Ethereum network, the transaction fees are paid in ETH (the native cryptocurrency of the Ethereum network) regardless of the tokens being transferred. This may be a challenge when such tokens are received, since they cannot be moved to another address until sufficient hosting blockchain cryptocurrency funds (ETH in this example) are also transferred to the payment processing transaction (PPT) address for paying the transaction fees. Transaction fees may further present challenges when calculating exchange rates and rewards because of the additional cryptocurrencies and tokens involved.

Another challenge includes the fact that transaction fees are not fixed but are instead dependent on current network demand and the willingness of miners or validators to process individual blockchain transactions based on the offered transaction fees. Since many transactions compete for validation based on the transaction fees offered, the transactions can be delayed based on the offered transaction fee. Such delays may not be acceptable to a user trying to record a transaction, necessitating a system for predicting a transaction fee amount which will allow the transaction to be included within a reasonable time. In some instances, it may be necessary to include additional transaction fees to prioritize existing transactions should the predicting system fail or not be accurate.

Accordingly, there is a need for a cryptocurrency payment reward system that overcomes these and other challenges and is able to allocate and deliver digital currency rewards to users in a timely and accurate manner.

### SUMMARY

Examples of the present disclosure provide a systems and methods for cryptocurrency payment reward allocation and delivery.

According to a first aspect of the present disclosure, a computer-implemented method for digital currency payment rewards is provided. The method may be implemented on a digital currency payment processing platform, having one or more component servers or computers. The method may include receiving, at a payment processing system, a payment processing transaction (PPT) request using a cryptocurrency payment from a consumer. The payment processing system determines that the request qualifies for the delivery of a cryptocurrency reward. The payment processing system confirms that the cryptocurrency payment is recorded in a distributed ledger. The payment processing system issues the cryptocurrency reward to a consumer based on the PPT request.

According to a second aspect of the present disclosure, a computer-implemented method for digital currency payment rewards is provided. The method may be implemented on a digital currency payment processing platform, having one or more component servers or computers. The method may include receiving a payment processing transaction (PPT) request for a digital currency payment. The method may also include determining that the PPT request qualifies for a digital currency reward. The method may additionally include obtaining a payment processing system wallet address for receiving digital currency payment. The method additionally includes confirming that the digital currency payment is recorded in a distributed ledger based on the payment processing system wallet address. The method may further include determining a consumer wallet address for sending the digital currency reward. The method may also include sending the digital currency reward to the consumer wallet address after a threshold time.

These and other aspects and advantages will become apparent to those of ordinary skill in the art by reading the following detailed description, with reference where appropriate to the accompanying drawings. Further, it should be understood that the foregoing summary is merely illustrative and is not intended to limit in any manner the scope or range of equivalents to which the appended claims are lawfully entitled.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram of a digital currency payment processing platform and rewards system, according to an example of the present disclosure.

FIG. 2 is a flow chart illustrating a method for cryptocurrency payment rewards, according to an example of the present disclosure.

FIG. 3 is a block diagram of a digital currency payment processing platform and rewards system illustrating a determination of whether a transaction is eligible for a reward, according to an example of the present disclosure.

FIG. 4A is a block diagram of a digital currency payment processing platform and rewards system illustrating a determination of wallet address to receive a reward, according to an example of the present disclosure.

FIG. 4B is a block diagram of the digital currency payment processing platform and rewards system of FIG. 4A.

FIG. 5A is a block diagram of a digital currency payment processing platform and rewards system illustrating a determination of wallet address to receive a reward, according to an example of the present disclosure.

FIG. 5B is a block diagram of the digital currency payment processing platform and rewards system of FIG. 5A.

FIG. 6A is a block diagram of a digital currency payment processing platform and rewards system illustrating a determination of wallet address to receive a reward, according to an example of the present disclosure.

FIG. 6B is a block diagram of the digital currency payment processing platform and rewards system of FIG. 6A.

FIG. 7 is a block diagram of a digital currency payment processing platform and rewards system illustrating a process for determining when to fund payment of a reward, according to an example of the present disclosure.

FIG. 8 is a block diagram of data communication of a digital currency payment processing platform and reward system, according to an example of the present disclosure.

FIG. 9 is a representation of a payment processing transaction (PPT) request, according to an example of the present disclosure.

### DETAILED DESCRIPTION

While the present invention is capable of being embodied in various forms, for simplicity and illustrative purposes, the principles of the invention are described by referring to certain embodiments thereof. It is understood, however, that the present disclosure is to be considered as an exemplification of the claimed subject matter and is not intended to limit the appended claims to the specific embodiments illustrated. It will be apparent to one of ordinary skill in the art that the invention may be practiced without limitation to these specific details. In other instances, well-known methods and structures have not been described in detail so as not to unnecessarily obscure the invention. For example, while embodiments herein are described with reference to cryptocurrency payments, it is understood that the systems and methods may be implemented similarly with respect to payments made via digital currencies or virtual currencies more generally. In addition, a merchant may directly interact directly with the payment processing platform services and application programming interface (API) functionality described herein, or may be a sub-merchant that indirectly accesses the payment processing platform services and API functionality through one or more intermediaries. Similarly, the merchant may indirectly interact with the consumer and provide access to the payment processing platform and rewards services and API functionality services through one or more intermediaries.

The terminology used in the present disclosure is for the purpose of describing particular embodiments only and is not intended to limit the present disclosure. As used in the present disclosure and the appended claims, the singular forms “a,” “an,” and “the” are intended to include the plural forms as well, unless the context clearly indicates otherwise. It shall also be understood that the terms “and” and “or” used herein is intended to signify and include any or all possible combinations of one or more of the associated listed items. As used herein, the term “if” may be understood to mean “when” or “upon” or “in response to a judgment” depending on the context.

The present disclosure relates to cryptocurrency payment rewards. In one or more embodiments, a merchant cryptocurrency payment system or payment processing system determines eligibility for a reward and sends a reward to a consumer based on a payment processing transaction (PPT) request. In this way, a merchant, cryptocurrency payment processor, or cryptocurrency issuer can incentivize the use of cryptocurrency, or of a specific type of cryptocurrency or token, as the form of payment for a transaction. This can be part of a reward program the merchant is part of. In one embodiment, the PPT request includes a request for processing a payment from a consumer to a merchant using cryptocurrency. In such an embodiment, the payor of a cryptocurrency payment gains a reward (in cryptocurrency, token, or by other means) upon making the payment. The reward can include a “tokenback” reward by which the payor receives a certain amount of cryptocurrency or token in return based on the payment transaction. For example, a consumer may pay a merchant using Ethereum when buying an item. The payment may be processed using a merchant cryptocurrency payment system that is capable of rewarding the consumer for paying with Ethereum by sending a certain amount of either Ethereum cryptocurrency or specific Ethereum tokens to their wallet address. Ethereum tokens can include ERC-20 Tokens, ERC-721 Tokens, ERC-1155 Tokens, and others. In one embodiment the tokenback reward comes from a tokenback reward pool that is maintained by the system. The reward pool contains cryptocurrency or tokens set aside for rewards, or issued for use as rewards.

The novel methods and systems provided for herein provide the advantage of allowing for the consumer to receive rewards without the need for the consumer to create a separate account (such as for a reward or loyalty program), and without the need to provide non-public information such as information associated with a financial institution (like a bank account) or personal information (such as a name or email account). As a result, the novel methods and systems provided for herein remove risks and barriers that might otherwise dissuade a user from participating in a rewards program. Through the embodiments provided herein, the delivery location for receiving the tokenback rewards is determined from details related to the payment transaction itself, obviating the need for the user to provide additional information in order to receive rewards, or to be considered for and receive loyalty rewards based on historical behavior. In one or more embodiments, a merchant cryptocurrency payment system or payment processing system determines from information contained in the PPT the appropriate digital wallet address associated with the consumer for receiving the tokenback rewards, and then implements payment of the tokenback rewards to the digital wallet address.

In an embodiment, the tokenback reward pool is administered by, for example, a merchant wallet or a token issuer wallet and hosted by the digital currency payment processing platform. The pool can be a separate wallet or a partition of a general wallet. In an embodiment, the tokenback pool is funded at certain time intervals. For example, each next pool starts or is funded on a specific date or day of the week and has new, set amount of tokens available for sending as rewards. In another embodiment, the tokenback pool has a large or infinite (or near-infinite) number of tokens available with no effective limitations for applying the rewards.

In one or more embodiments, the amount of tokenback rewards in circulation is adjusted based on external stimuli in the tokenback reward environment. In an embodiment, the disposition of the tokenback reward is based upon consummation of a transaction and includes a portion of the tokenback reward being destroyed. For example, once a token back reward is used in a transaction, such as for payment to a merchant, the tokenback reward may be destroyed or burned to lower the amount of token back rewards in circulation. In such an example, the token issuer or payment processor determines the amount of tokens to be destroyed (or disposed of or retired) upon being spent for payment. The process of destroying tokens can include an automated or partially automated process. An automated process includes the payment processing engine calculating the amount of tokens to be destroyed according to defined parameters, such as the number of tokenback rewards in circulation, the number of tokenback rewards being actively traded, and the monetary value of the tokenback rewards. The tokens are destroyed or removed from circulation, for example by sending the tokens to a dedicated blockchain address (e.g., customary address for this purpose on Ethereum is 0×0) or by destroying the tokens by calling the burn( ) or equivalent function in the smart contract by API (or manually).

In another embodiment, the number of tokenback rewards in circulation is controlled by issuance or repurchase of tokenback rewards through trading algorithms based on tokenback reward data. Tokenback reward data can include sale price (including initial and subsequent sale price) and volume of tokenback rewards. Tokenback reward data can also include the absolute or relative price of the tokenback reward, absolute or relative trading volume, or any combination thereof. For example, the algorithm for the release and repurchase (or buyback) of tokenback rewards can provide for a daily release of a set percentage of new tokens, such as 10-20%, if the price is higher than that of a previous day. Alternatively, instead of a set amount, the algorithm for the release and repurchase of tokenback rewards can provide for a daily release of a variable percentage where the variable percentage is a function of the difference between the current or closing price of the tokenback reward on a given day versus its price the previous day. In another example, the algorithm will not release new tokens if the price of the tokenback rewards is lower than or equal to that of the previous day. Such an algorithm can operate on a daily basis or on a weekly basis, for example, wherein it operates by providing for the release of ⅙ of the weekly tokens each weekday and 1/12 of the tokens each Saturday and Sunday, with, for example, 10,000 tokens released each week.

As noted above, a trading algorithm can also operate to repurchase or buy back tokens, such as when the current price meets a first predetermined threshold (for example 5% below the average price for the seven previous trading days). The algorithm can provide for a buyback of tokens until (i) this condition is no longer met or (ii) the number of tokens repurchased equals the number of tokens sold during the seven previous trading days. Should condition (ii) be met and the current price meets a second predetermined threshold (for example, 5% below the average price for a set number of previous trading days), the algorithm will buy back tokens until (iii) this condition is no longer met or (iv) the number of tokens repurchased equals the number of tokens sold during the set number of previous trading days. In one embodiment, the trading algorithm continues this calculation for each seven-day period until the first or second predetermined threshold is no longer met.

Using the above methods, a unique digital currency token or cryptocurrency can be created and managed in such as way as to promote the adoption and initial use of the token, and provide increased stability of the token or cryptocurrency thereafter in order to promote sustained use thereof. For example, in an embodiment the issuer of the digital currency token or cryptocurrency sets the properties of the token rewards, including the amount, and uses the other techniques above (such as removing tokens from circulation, repurchasing tokens, or issuing new tokens). Given the ability to issue rewards to a consumer based solely on their use of given digital currency or cryptocurrency, and without the need for the consumer to set up a separate rewards account, it is easier to control the amount of rewards in circulation and therefore control the value of the underlying digital currency or cryptocurrency.

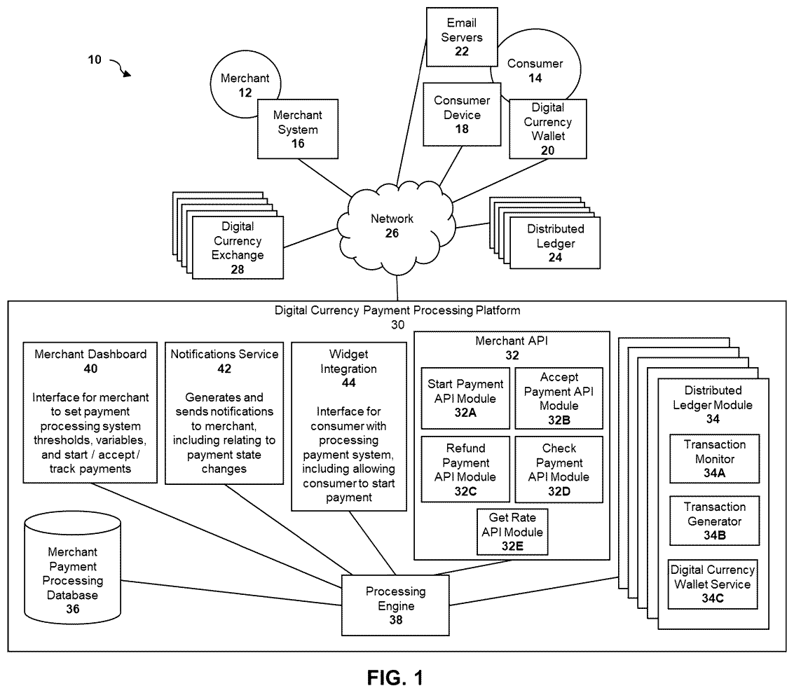

Turning now to the figures, FIG. 1 shows a digital currency payment processing system 10 according to an embodiment of the present disclosure. The digital currency payment processing system 10 allows for processing payment transactions between a merchant 12 and one or more consumers 14. The digital currency payment processing system 10 includes a merchant system 16, consumer device 18, digital currency wallet 20, email servers 22, one or more distributed ledger components 24, and digital currency payment processing platform 30. The system also connects with one or more exchanges 28 to determine exchange rates among and between digital currencies and fiat currencies.

The merchant system 16 provides a platform by which goods or services can be purchased by a consumer. In one embodiment, the merchant system 16 is a website operating on one or more servers having an interface, such as a webpage or series of webpages capable of being displayed on consumer devices, through which a consumer can select goods or services for purchase, and then proceed to a purchasing interface, such as a “checkout” page or webpage having similar functionality, where the consumer can proceed with purchasing the selected goods or services. The merchant system 16 may provide the consumer with a variety of goods or services available for purchase from the merchant, and with the ability to select goods and services for purchase by the consumer. Once identified, the merchant system 16 provides the consumer with a total price for the purchase of the goods and services, and further provides the consumer with the ability to identify a means for payment, including one or more digital currencies or cryptocurrencies. In another embodiment, the merchant system 16 is situated at a brick-and-mortar location and is a point-of-sale (POS) system or similar device through which a merchant representative or consumer identifies goods or services for purchase (such as by scanning barcodes attached to such goods), and then proceeds to purchase the goods or services. In such a brick and mortar embodiment, the consumer 14 interacts directly with the merchant in person, as opposed to over a network and through a consumer device, and may rely on a merchant representative, such as a sales representative or employee, to interact with the merchant system (e.g., POS system).

The merchant system 16 connects to the digital currency payment processing platform 30 via an application programming interface (API) connection and invokes the functionality of platform 30 via one or more API calls, as further described below. For security purposes, the API connection is secure, and the merchant system 16 must undergo an authentication process using an API key in order to connect to the payment processing platform.

In addition, the merchant system 16 registers with the digital currency payment processing platform 30 to receive real-time notifications from the platform. The server of the payment processing platform 30 then provides the merchant system 16 with real-time notification when a cryptocurrency payment is sent by the payor to the merchant, and can also send notifications when the payment sent by the payor is not equal to the expected payment (i.e., it is greater to or less than the expected payment). The server of the payment processing platform 30 can also send notifications to the merchant system 16 when a payment sent by the payor that is not equal to the expected payment was automatically accepted because it was within a certain payment amount threshold set by the merchant, or when a payment was automatically rejected because it exceeded such thresholds. The server of the payment processing platform 30 can also send a notification to the merchant system 16 to prompt the merchant for a response regarding actions to be taken (such as acceptance of a payment, rejection of a payment, or issuance of a full or partial refund regarding excess payments) when the payment sent by the payor is not equal to the expected payment, or when the payment sent by the payor exceeds the payment amount thresholds set by the merchant.

As discussed herein, consumer 14 is broadly defined to encompass any persons, entities, or future programs or intelligence capable of or desiring to make a transaction for the goods or services with the merchant system 16. For purposes of illustration, the consumer is an individual seeking to purchase goods or services through interactions with the merchant system 16. In an embodiment where the merchant system 16 is presented through a website, consumer 14 interacts with the merchant system 16 through the consumer device 18, such as a computer or mobile device, via a communication network 26. In embodiments where the consumer is able to interact directly with the merchant system 16, such as brick and mortar establishments, the consumer 14 may interact with the merchant system 16 without the aid of the consumer device 18, and may instead interact with the merchant system 16 directly or through the assistance of a merchant representative, such as a sales associate.

Consumer device 18 is an electronic device through which consumer 14 can interact with other components of system 10 via network 26 or any other communication medium. The consumer device 18 has a display through which the consumer 14 can be presented with visual information generated by other components of system 10, such as the merchant system 16, the digital currency wallet 20, and one or more distributed ledgers 24, which may be cryptocurrency blockchains. In addition, the consumer device 18 has one or more input devices through which the consumer 14 can provide input, such as a physical keyboard, a mouse, or a touchscreen display. The consumer device further includes one or more network interfaces through which it can transmit and receive data via a network, such as network 26. The consumer device 18 can be, but is not limited to, an electronic device having input/output, processing, and data communication capabilities, such as desktop, laptop, and tablet computers, mobile phones, personal digital assistants, and gaming devices. The consumer device 18 provides consumer 14 with the ability to interact with the merchant system 16 to browse goods or services made available by the merchant for purchase by the consumer, select goods or services for purchase along with delivery options for such goods and services, and provide payment information to complete the purchase of such goods and services. In one embodiment, the merchant's device for consumers is physically located at a brick-and-mortar location and is a customer-facing POS device through which a consumer can identify and select goods and services for purchase through interaction with the merchant system 16. At the control of the consumer 14, the consumer device 18 communicates with the merchant system 16 and the digital currency wallet 20 via the network 26.

Digital currency wallet 20 is a consumer's system or software for securely storing and managing one or more digital currencies. In one embodiment, the digital currency wallet is a cryptocurrency (or blockchain) wallet service. Known wallet services include devices, physical mediums, programs or online services that store public and private keys for digital currency and cryptocurrency transactions, and allow for the sharing of public keys for purposes of receiving or exchanging funds. Digital currency wallet 20 provides for the storage of private keys for consumer 14, allowing the consumer to gain access to cryptocurrency funds. In this way, the digital currency wallet 20 holds the passwords used to access the cryptocurrency stored on the distributed ledger 24, which may be a cryptocurrency blockchain. Digital currency wallet 20 may further include programming and capabilities that allow consumer 14 to manage their digital assets, including by providing consumer 14 with control of the consumer's private keys, providing the ability to send and receive digital currency and cryptocurrency, and providing the ability to conduct transactions. For example, digital currency wallet 20 keeps a record of all transactions (e.g., sell, buy, exchange transactions) related to consumer's cryptocurrency and operates to send such transactions on one or more distributed ledgers 24. In one embodiment, the consumer 14 interacts with the digital currency wallet 20 via a consumer device 18 and through a network 26. Alternatively, the digital currency wallet 20 may be accessed via a separate device. The digital currency wallet 20 communicates with the distributed ledger 24 through the network 26.

The distributed ledger 24 stores the details of transactions related to digital assets. The distributed ledger may be any shared digital data system that provides for replicated, shared, and synchronized digital data in order to record the transaction of digital assets. One example of a distributed ledger 24 is a cryptocurrency blockchain network. Distributed ledger 24 may be a public, private, or hybrid public-private network, or may be any other type of network that supports distributed ledger technology. In one embodiment, the distributed ledger is a blockchain for a cryptocurrency and operates as a public, decentralized ledger that tracks each transaction that occurs on the network associated with the cryptocurrency. In another embodiment, the distributed ledger 24 is a private blockchain. In yet another embodiment, the distributed ledger 24 is a hybrid blockchain technology that includes both public and private characteristics. The present invention contemplates all present and future forms, developments, and iterations of blockchain technology and their corresponding networks. The distributed ledger 24 is accessible by the digital currency wallet 20 and the digital currency payment processing platform 30 by way of a communication network, which may be network 26 or a different network. Through the use of a digital currency wallet, a user can provide for the transfer of digital assets by recording a transaction of those digital assets. For example, the consumer can use the digital currency wallet 20 to send a transaction of cryptocurrency from his wallet to the merchant on the distributed ledger 24. The digital currency payment processing platform 30 is able to view entries on the distributed ledger 24, and to monitor for transactions occurring on the distributed ledger related to the purchase of goods and services from the merchant by the consumer. The digital currency wallet communicates with the distributed ledger 24 via network 26.

The network 26 may be any network for facilitating communications of data and information between systems, whether wired, wireless, or both, including all presently known communication protocols or those later developed. The network 26 may be any wired network, wireless local area network (LAN), or wide area network (WAN), or a combination of such networks. The network 26 may further be the Internet, or an extranet or intranet, or any combination thereof, or any later developed network technology that facilitates communications and information transfer. The network 26 may use a standard communication technology or protocol such as 3G, 4G, 5G, 802.11, 802.16, or Ethernet. Additionally, the network 26 is capable of using any wired, wireless, or combination of wireless and wired communications technologies, including a variety of communication protocols. It is contemplated that the network 26 may include any communication protocol such as file transfer protocol, hypertext transport protocol, simple mail transfer protocol, and transmission control protocol/Internet protocol. The network 26 functions as the network facilitating communications between the invention's elements. In one embodiment of the invention, the network 26 communicates with the merchant system 16, the consumer device 18, the consumer 14 via the consumer device 18, the digital currency wallet 20, the one or more distributed ledgers 24, the one or more exchanges 28, and the digital currency payment processing platform 30. The distributed ledger 24 communicates with other system components, such as the digital currency wallet 20 and digital currency payment processing platform 30 through a network, which may be the same as network 26 or a different network, or a collection of networks.

The digital payment processing platform 30 provides the interface and functionality through which the merchant system 16 is able to facilitate and process digital currency used by the consumer as payment for goods or services purchased from the merchant. The digital payment processing platform 30 may be housed on one or more servers housed locally with the digital currency processing provider, or externally with one or more cloud computing service providers, or a combination thereof. The digital currency payment processing platform 30 includes a merchant API 32, a merchant payment processing database 36, and one or more distributed ledger modules 34, which, in the case of cryptocurrency may be termed a blockchain module. The merchant API 32 includes various API modules through which the merchant can invoke the functionality of the digital currency payment processing platform. These modules include a start payment API module 32A, a check payment API module 32D, an accept payment API module 32B, and a refund payment API module 32C, and a get rate API module 32E, whose functionality are described in greater detail below. The digital payment processing platform 30 also includes a merchant dashboard 40, a notifications service 42, and a widget integration 44, each of which is described in greater detail below. The digital payment processing platform 30 also includes a processing engine 38 for processing inputs and outputs to the system and the various sub-components, and for handling communications therebetween.

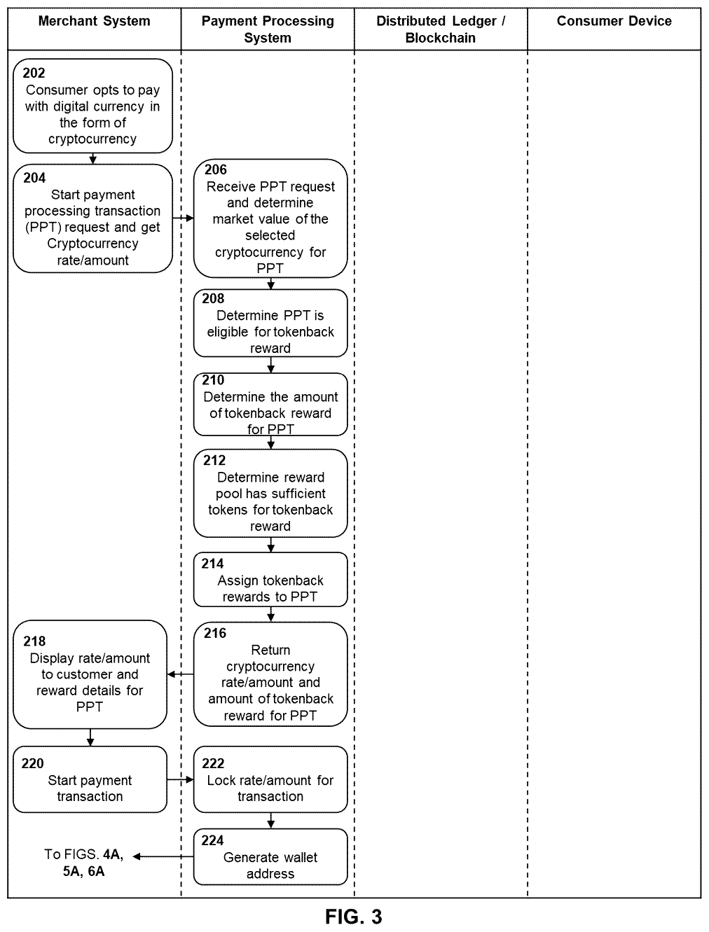

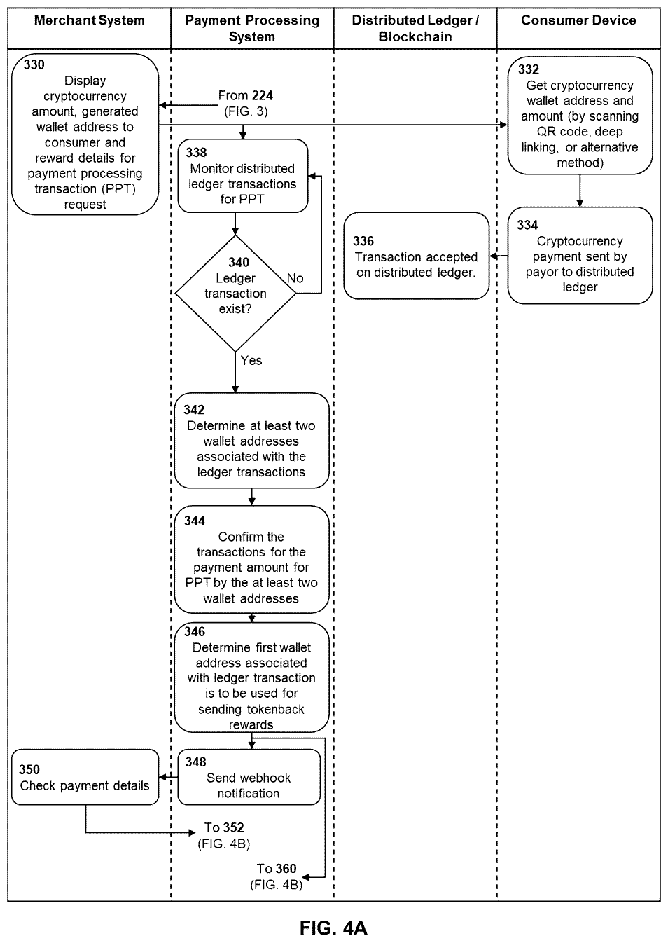

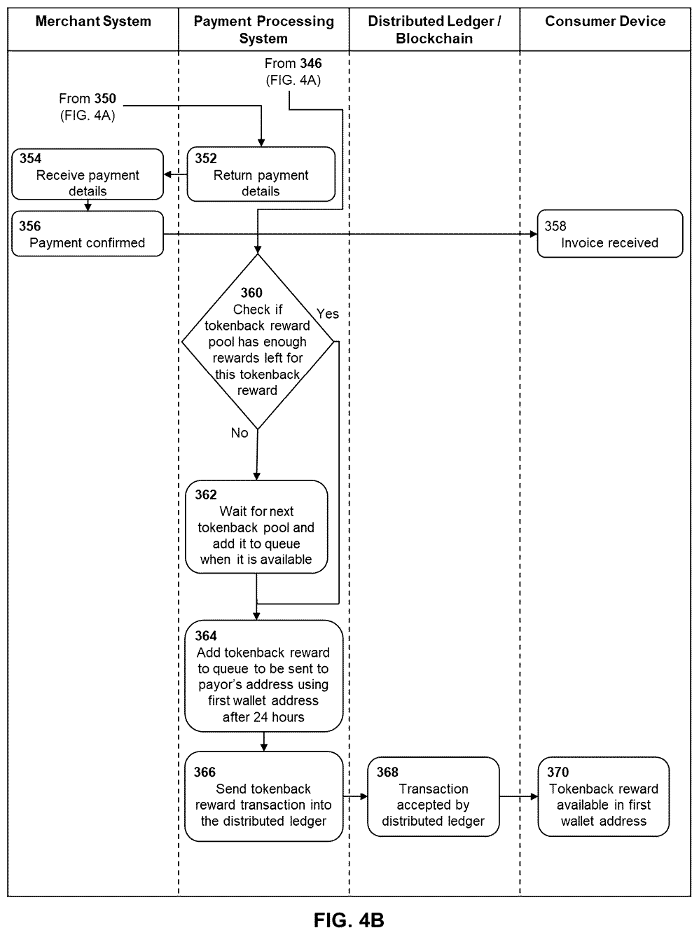

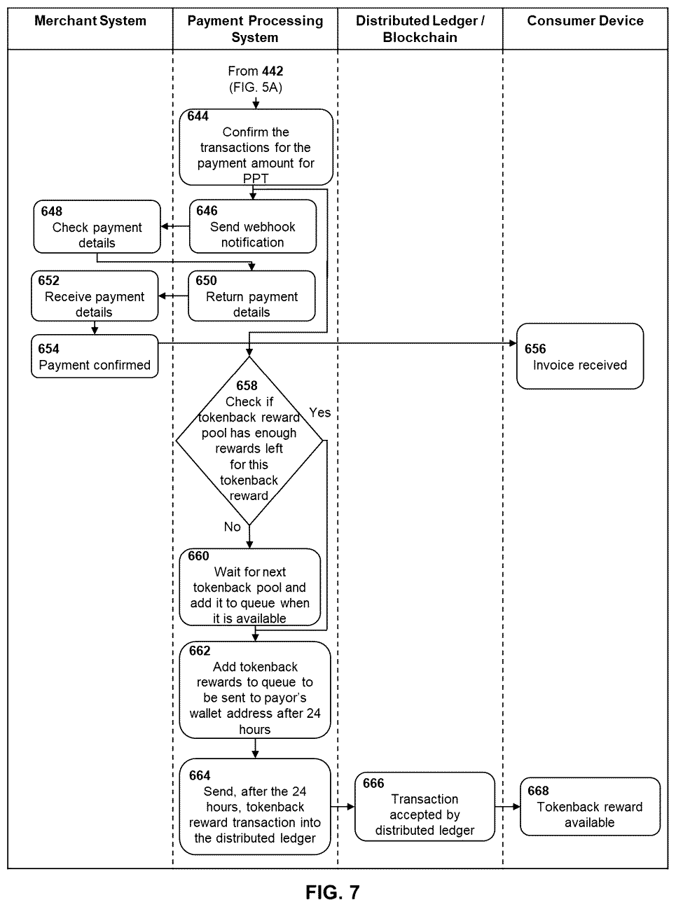

The digital payment processing platform 30 further includes a tokenback module 39 for handling tokenback rewards. The sub-modules in the tokenback module 39 include a tokenback address oracle 39A for determining the reward address based on transaction details, (see FIGS. 4A-6A, discussed below), a tokenback eligibility checker 39B for determining eligibility for the reward, (see FIG. 3, discussed below), a tokenback pool handler 39C for handling the amount of tokens available for rewards and optionally postponing rewards, (see FIG. 7, discussed below), and a tokenback reward distributor 39D for sending rewards to a reward address or addresses, (see FIG. 4A, discussed below).

The distributed ledger systems or blockchain modules 34 each includes a transaction monitor 34A for the distributed ledger, a transaction generator service 34B, and the platform's digital currency wallet services 34C, the functionality of each of which is described in greater detail below. The merchant profile database 36 stores information and variables related to the merchant's use of the digital currency payment processing platform. The database 36 stores payment processing information, including variables and information relating to merchants, payments, transactions, settlements, as well as user information, including login information such as usernames, passwords, and session information. Although database 36 is shown as a single database, separate databases may be used to store the information used by the system. In one embodiment, the database 36 includes a main database that includes information relating to merchants, payments, transactions, settlements, and other information related to the processing of payments by merchants; and a user database that includes login information, usernames, passwords, session information, and other information related specifically to users. In other embodiments, duplicate data may be stored across multiple databases to provide redundancy for purposes of data integrity or to provide backup data availability in the event of system failures. The digital currency payment processing platform 30 interacts with the merchant system 16, and distributed ledger 24 via a communications network, such as network 26.

The merchant dashboard 40 provides a visual interface to the merchant allowing the merchant to access and implement the functionality provided by the API. The merchant dashboard allows the merchant to set up API keys to use with API 32 and configure widget integration 44. It also allows the merchant to start, check, confirm and cancel payments, as well as view information relating to payments, such as viewing a list of all payments that were made. Merchant dashboard 40 is also used to configure notifications to the merchant, as well as set webhook notifications (described herein). The notifications that the merchant can configure include, for example, an option to send an email notification to the merchant regarding certain payment milestones, such as when payment starts, when it is confirmed, when it is canceled, or other milestones or events.

Notification service 42 provides the functionality required for sending notifications, including webhook notifications and email notifications. When email notifications are set on the merchant dashboard 40, the merchant will receive emails for payment milestones, including when a payment starts and upon payment confirmation. Notification service 42 also handles webhook notifications according to their configuration via the merchant dashboard 40. Webhook notifications are sent when a payment state changes, and also for each confirmation change on a pending payment.

Widget integration 44 allows a merchant to easily integrate and provide payment options on their website without creating full API integration and creating their graphical user interface (GUI) implementation to interact with the payment.

The merchant API 32, along with the merchant dashboard 40 and widget integration 44, provides the interface through which the merchant can call upon the functionality of the digital currency payment processing platform, including the functionality provided by the modules within the merchant API. As described in greater detail below, the start payment API module 32A is called by the merchant system (or manually from the dashboard or widget) to start the payment. The processing engine retrieves variables from the database 36 related to processing a consumer payment and initiates payment processing based on those variables and based on the details of the transaction, such as the type of digital currency or cryptocurrency, the amount of fiat currency being invoiced or requested by the merchant, the corresponding amount of the digital currency or cryptocurrency calculated for a given amount of fiat currency based on the exchange rate (including any surcharges or fees, such as blockchain transaction fees or exchange fees), and a transaction identifier. The accept payment API module 32B is the API endpoint that accepts the payment when called from the merchant system 16 (for example when the paid amount was too low or the transaction was late. Payment can also be accepted by the processing engine 38 in scenarios where payments are started with parameters that include automatic acceptance of a payment if it falls within the desired threshold that has been set by the merchant system 16. The refund payment API module 32C is the API call that initiates a refund for a transaction that is rejected or partially rejected by the merchant system 16, whether due to an overpayment, underpayment, or late payment. The check payment API module 32D is the API call used to check the details of a given payment, including such details of whether a payment is confirmed or cancelled, how much digital currency or cryptocurrency was received, and the status of a payment (such as whether the payment is awaiting confirmation). In general, when the merchant system 16 receives a webhook notification from the payment processing platform 30, the system will initiate a check of the payment details for a given payment via the check payment API module 32D. The merchant system 16 can also periodically request payment details via the check payment API module 32D when no webhook is received. In one embodiment the webhook notification itself includes the payment detail information that would otherwise be provided by calling the check payment API.

The distributed ledger modules 34 interact with distributed ledgers and cryptocurrency blockchains in order to monitor and effectuate digital currency and cryptocurrency transactions. The distributed ledger module 34 includes a transaction monitor service 34A, a transaction generator service 34B, and a digital currency wallet service 34C. Transaction monitor service 34A periodically reviews entries in distributed ledgers, such as cryptocurrency blockchains, for transactions corresponding to expected payments from a consumer to the merchant, and generates notifications concerning the existence and details of the transaction so that these details can be added to the database and provided as needed (for example, in response to a call to the check payment API module 32D). Transaction generator service 34B generates distributed ledger transactions (such as full or partial refunds of payments from consumers), signs those transactions, and sends (or broadcasts) those transactions onto distributed ledger networks, such as cryptocurrency blockchains, as described in greater detail below. The digital currency wallet service 34C connects the system to one or more exchanges 28 to determine exchange rates among and between digital currencies and fiat currencies. The platform 30 uses the exchange rate to convert the requested fiat currency for a given transaction into a corresponding digital currency amount. The connection to the exchanges 28 provided by the digital currency wallet service 34C further allows the platform 30 to send digital currencies received via the one or more distributed ledgers 24 to one of the exchanges 28 so that it can be converted to fiat currency (or another digital currency).

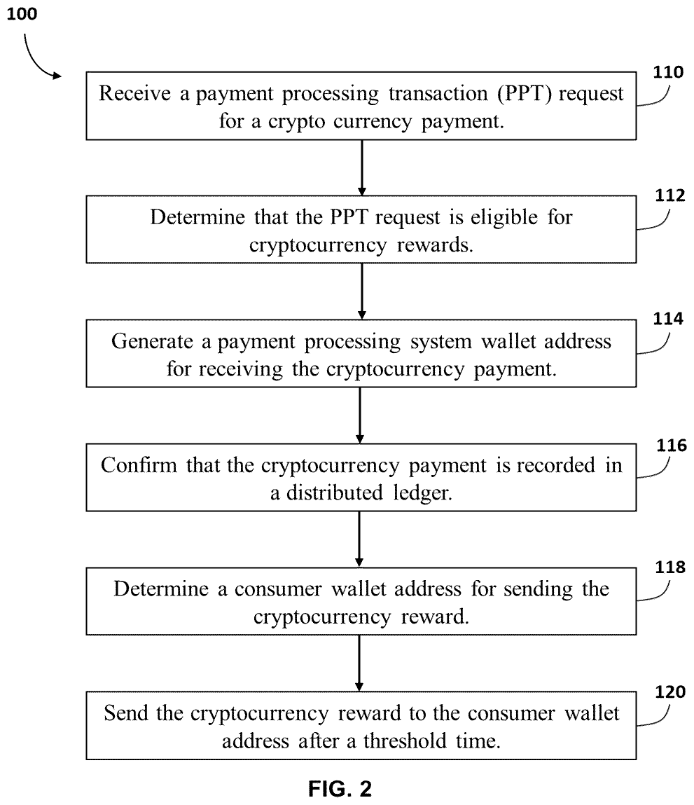

FIG. 2 shows an example method for cryptocurrency payment rewards in accordance with the present disclosure. The method can be applied on the digital currency payment processing platform 30, server, or computer system. In an embodiment, the method is performed, at least in part, by the processing engine 38 and tokenback module 39.

In step 110, the digital currency payment processing platform 30 receives a payment processing transaction (PPT) request for a cryptocurrency payment. In one embodiment, the PPT request comes from the merchant system 16 in response to a consumer opting to pay for a transaction using a cryptocurrency. (See also step 206 in FIG. 3 discussed below.)

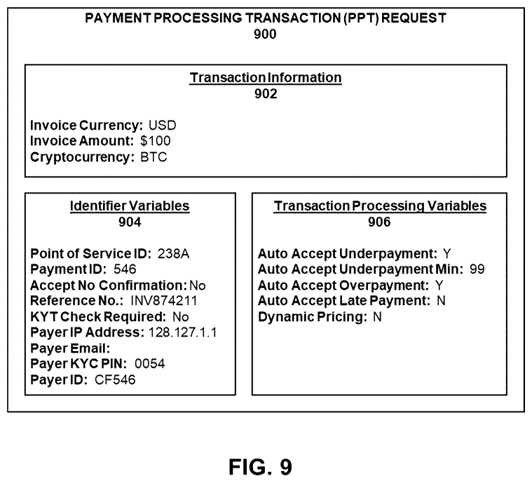

As shown in FIG. 9, the PPT request 900 contains the necessary transaction information 902 to process the cryptocurrency payment transaction, including fields directed to the invoice currency (i.e., the fiat currency the payment is required in), the amount to be charged in the invoice currency (i.e., the amount on the invoice in the fiat currency), and the cryptocurrency.

The entry in the invoice currency field is specified by a code corresponding to the fiat currency on the invoice (e.g., USD, EUR, etc.). The entry for the cryptocurrency is specified by a code or symbol corresponding to a given cryptocurrency (e.g., BTC, ETH, etc.). The PPT request optionally includes fields to provide other information relevant to the transaction, such as information and variable fields relating to identifiers and security check information for the merchant and payer 904, and transaction processing parameter fields 906 specifying how the system should handle certain payment scenarios, such as payments of incorrect amounts (i.e., cryptocurrency amounts that are not equal in value to the invoice fiat amount).

The identifier variable fields 904 can also include the following: a payment identifier (“Payment ID”) field assigned to the PPT by the merchant system in order to track it in the system; a point of service identifier (“Point of Service ID” or “POS ID”) field identifying the point of service for the PPT request; a reference number (“Reference No.”) field for the merchant's records, which may be the same as an invoice number or order number; a payer IP address (“Payer IP Address”) field for an IP address associated with the payer; a payer email address (“Payer Email”) field for an email address for the payer; a payer know your client (KYC) PIN (“Payer KYC PIN”) field for a KYC PIN code or other KYC identifier for a consumer; and a payer identifier (“Payer ID”) field for an identifier for the payer that may be assigned by the merchant system. In one embodiment, the payment identifier is generated and assigned to the PPT by the Start Payment API module 32A in the Merchant API 32. The identifier variable fields 904 may also include a variable field to confirm a payment without the user providing information to confirm his or her identify (“Accept No Confirmation”), which may be set when the point of service is situated that it is possible to confirm the identity of the user without such information, such as when the point of service is under video surveillance. The identifier variable fields 904 can further include a field to designate that a know your transaction (KYT) check must be performed and passed before confirming the transaction (“KYT Check Required”), which can be set as true/false, yes/no, or likewise to indicate whether such check is required.

The transaction processing parameter fields 906 of the PPT request 900 can include the following: an auto accept underpayment (“Auto Accept Underpayment”) field to indicate whether the system should automatically modify the invoice amount and accept the payment if the paid amount is lower than requested; an auto accept underpayment minimum field (“Auto Accept Underpayment Min”) to set a threshold for the paid amount (in the invoice currency) such that the auto accept underpayment setting is only applied if the paid amount is equal or greater than the threshold; an auto accept overpayment (“Auto Accept Overpayment”) field to automatically modify the invoice amount and accept the payment if the paid amount is higher than requested; an auto accept late payment (“Auto Accept Late Payment”) field to automatically modify and accept the payment if the transaction was received late and either the paid amount is similar to the invoice amount or if acceptance of the paid amount (although different from the invoice amount) is allowed by the other auto accept conditions (e.g., auto accept underpayment, auto accept overpayment, etc.). In another embodiment, the merchant system 16 may be capable of implementing dynamic payment processing wherein the system automatically accepts the paid cryptocurrency amount using the rate at the time the blockchain transaction was accepted, and where the transaction processing parameter fields 906 may include a dynamic pricing (“Dynamic Pricing”) field to indicate that dynamic payment processing should be applied. Each of the fields in the transaction processing parameter fields 906 can be set as true/false, or yes/no, or likewise to indicate whether the respective transaction processing conditions should or should not be applied for a given payment processing transaction request.

In step 112, the tokenback eligibility checker 39B determines that the PPT request is eligible for cryptocurrency rewards. Whether a PPT request is eligible for cryptocurrency rewards can depend on a variety of conditions and thresholds. In one embodiment, eligibility for a cryptocurrency reward is conditioned on the use of cryptocurrency or a specific type of cryptocurrency or a token. In another embodiment, eligibility for a cryptocurrency is additionally or alternatively conditioned on the amount of the PPT request exceeding a given threshold amount. In this way, a merchant or consumer can be incentivized to pay for the transaction through the use of cryptocurrency, or a specific type of cryptocurrency or token. In addition, these conditions and thresholds may vary over time in order to vary such incentives and tailor them according to changes in circumstances and to target certain individuals or entities. (See also step 208 in FIG. 3 discussed below). In one embodiment the conditions and thresholds are maintained in the database 36 of the digital currency payment processing platform 30, where they can be set and modified by the merchant 12, the provider of the digital currency payment processing platform 30, or by a third party (e.g., cryptocurrency or token issuers) via an interface to the payment processing platform 30. In another embodiment, the conditions and thresholds are maintained in a remote database where they are set and modified by a third party, and wherein the payment processing platform 30 accesses such third party database periodically or based on push requests from the remote database when such variables have been updated, and stores the conditions and thresholds locally for use in determining whether a PPT request is eligible for cryptocurrency rewards.

In an embodiment, at step 112 the tokenback eligibility checker 39B further determines the form of the reward and its characteristics, such as the type of cryptocurrency or token that will be used for the reward, and the amount of reward. For example, the reward can be set as a percentage of the payment amount, a fixed amount, or a fixed value. Like the reward eligibility conditions and thresholds, the form of the reward and its characteristics are maintained in the database 36 of the digital currency payment processing platform 30, where they can be set and modified by the merchant 12, the provider of the digital currency payment processing platform 30, or by a third party (e.g., cryptocurrency or token issuers) via an interface to the payment processing platform 30. Alternatively, the form of the reward and its characteristics are maintained in a remote database where they are set and modified by a third party, and wherein the payment processing platform 30 accesses such third party database periodically or based on push requests from the remote database when such variables have been updated, and stores the reward information locally for use in determining the form and characteristics of the cryptocurrency rewards.

In one embodiment, the percentage of the payment amount used to determine the cryptocurrency reward amount includes a predetermined percentage of the payment amount value, for example, 5% of the payment amount. For example, where the payment amount is 100 tokens of a cryptocurrency, the reward amount may be 5 tokens. In another embodiment, the percentage of the payment amount varies depending on the product (or the category of the product), the size of the transaction, the time period when the payment was made, any surcharges or fees, such as blockchain transaction fees, network fees, or exchange fees, or a part thereof, or the availability of the amount of tokens for rewards in a certain time-period (by the determination of the time-period and the amount of available tokens in that time-period).

The amount of the cryptocurrency reward can also be subject to one or more limitations on the available number of tokens. These limitations can be based on, for example, a percentage of the number of tokens outstanding, issued, or released, an absolute number of tokens outstanding, issued, or released; or an absolute value of tokens outstanding, issued, or released.

In another embodiment, the reward is merchant-based, where the reward percentage is set by the merchant involved in the transaction.

In another embodiment, the reward is based on the value of a fiat currency such that the reward is set to a specific number of tokens that corresponds to a given amount in fiat currency. For example, where the cryptocurrency reward amount is set based on a percentage of the payment amount, such as 5%, and if the payment amount value is $100 USD (or the equivalent value in cryptocurrency), then the cryptocurrency reward will be the amount of the number of cryptocurrency reward tokens that may correspond to $5 USD. The reward may also be based on a set value, for example, $100 absolute value in fiat currency, regardless of the payment amount or based on an amount being paid over a predefined threshold.

In another embodiment, the cryptocurrency reward amount also takes into account transaction fees or other blockchain related items like gas fees or network congestion fees. In one instance, the overall amount of the reward is reduced by such fees or a portion of such fees. Alternatively, some or all of these fees are deducted from the payment amount before applying the percentage of the payment amount used to determine the cryptocurrency reward amount. For example, in determining the reward amount these fees may be deducted from the payment amount (e.g., the 100 tokens of cryptocurrency or the $100 in fiat currency) before applying the percentage of the payment amount (e.g., 5%).

In another embodiment, whether a payment qualifies for a reward is based on the specific cryptocurrency used to pay the merchant. For example, the payment can qualify for rewards if the consumer is using Bitcoin or Ethereum but no rewards if they are using ADA or AVAX cryptocurrencies. In another example, the amount of the reward varies based on the specific cryptocurrency used to pay the merchant. For example, the reward amount (either as a percentage of the payment amount or an absolute value of the reward) may be higher for consumers using Bitcoin instead of Ethereum.

Where the cryptocurrency reward is based on a fixed amount, the fixed amount can be based on a predetermined fixed amount, a fixed amount depending on the product (or category of the product), on the size of the transaction, on the time period when the payment was made, or on the availability of the amount of the tokens for rewards in a certain time-period (by the determination of the time-period and the amount of available tokens in that time-period). The limitations of available number of tokens can be set as, for example, a percentage of the number of tokens outstanding, issued or released, an absolute number of tokens, or an absolute value of tokens.

The fixed value can be based on a predetermined fixed value or a fixed value depending on the product (or category of the product), on the size of the transaction, on the time period when the payment was made, or on the availability of the amount of the tokens for rewards in a certain time-period (by the determination of the time-period and the amount of available tokens in that time-period). The limitations of available number of tokens can be set as, for example, a percentage of the number of tokens outstanding, issued or released, an absolute number of tokens, or an absolute value of tokens.

In an embodiment, the reward is determined and set by the merchant 12, a token issuer, or the transaction processor, such as the provider of the digital currency payment processing platform 30. The entity determining the form and characteristics of the reward can use an API or dashboard to access and set the reward characteristics.

In an embodiment, the reward can vary based on the type of cryptocurrency used for payment and for reward. In one embodiment, the amount of the reward received may scale inversely based on the amount of transaction fees associated with a given cryptocurrency, such that a cryptocurrency with higher transaction results in a lower reward amount and a cryptocurrency with lower transaction fees results in a larger reward amount. For example, the transaction fees can be lower on the POLYGON blockchain compared to the Ethereum blockchain. Therefore, the payer, which also pays for the network fees for receiving the reward, can receive more POLYGON tokens as a reward when choosing POLYGON as the reward rather than Ethereum.

In step 114, the digital currency payment processing platform 30 generates a payment processing system wallet address for receiving the cryptocurrency payment. (See also step 224 in FIG. 3 discussed below).

In step 116, the digital currency payment processing platform 30 confirms that the cryptocurrency payment is recorded in a distributed ledger. (See also, for example, step 340 in FIG. 4A discussed below).

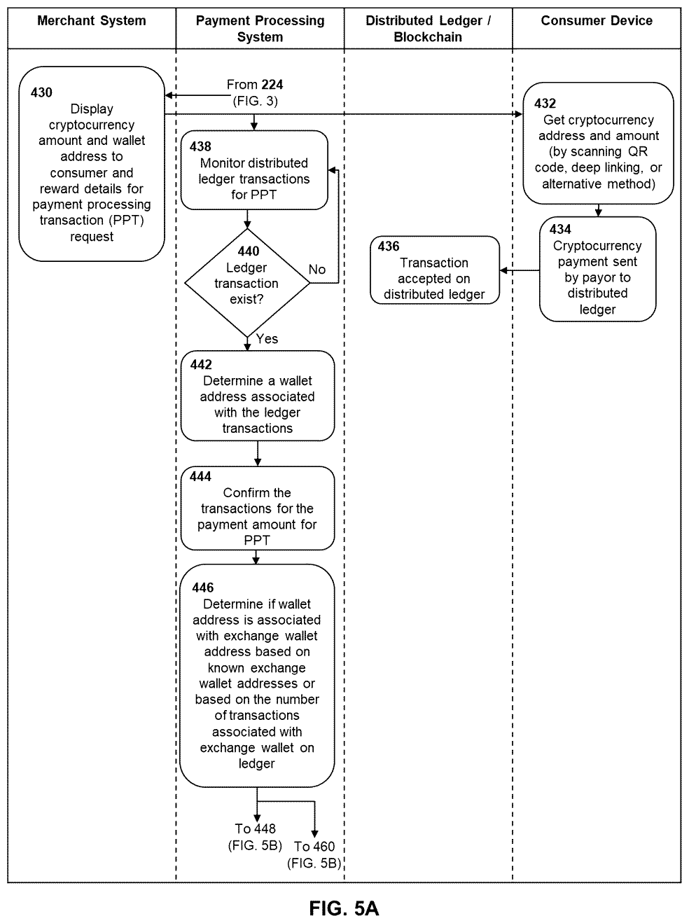

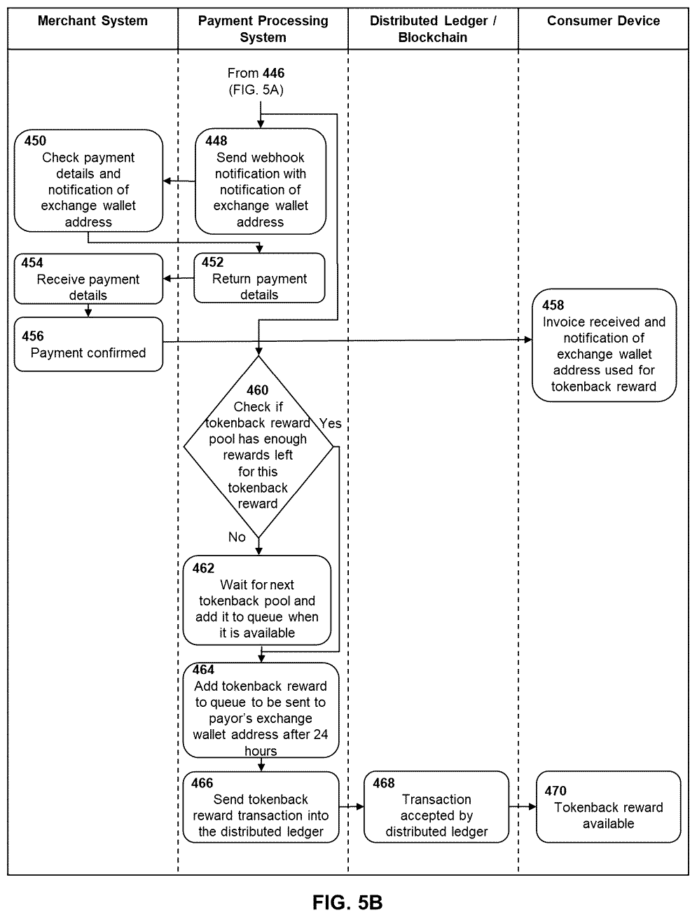

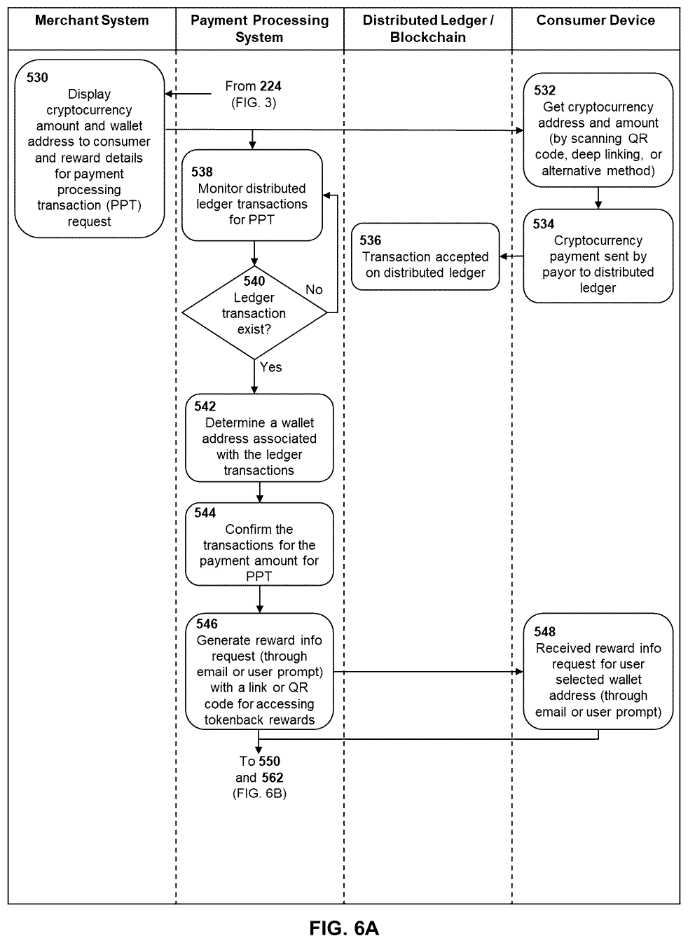

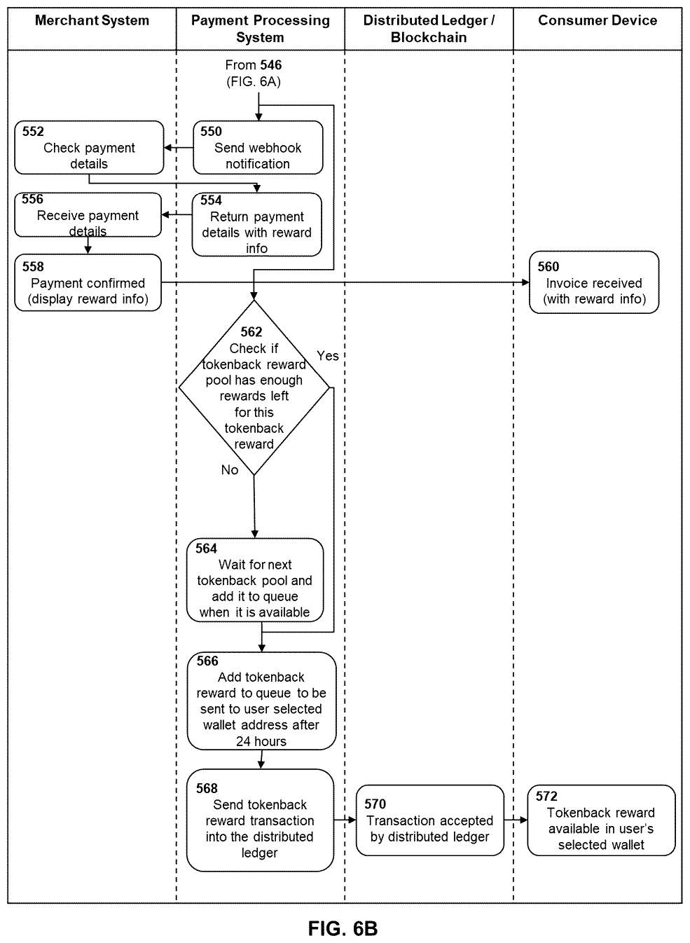

In step 118, the tokenback address oracle 39A determines a consumer wallet address for sending the cryptocurrency reward. (See also step 346 in FIG. 4A, 446 in FIG. 5A, and 546 in FIG. 6A discussed below). The tokenback address oracle 39A can also determine an exchange wallet, private wallet, hardware wallet, software wallet, or other types of wallets for sending the cryptocurrency reward. There are multiple ways in which the tokenback address oracle 39A can determine the address to which the tokenback reward should be sent to. In one embodiment, the address is supplied by the consumer 14 or by the merchant 12. In another embodiment, the tokenback address oracle 39A matches a consumer identifier to a set of stored addresses. In yet another embodiment, the tokenback address oracle 39A uses the address from which the payment for goods or services was made. The tokenback address oracle 39A can also verify that the address is a private address (and not, for example, an address used for withdrawals from a third party digital currency exchange) and stop the reward from being paid out to an address from which it would be difficult or impossible for the consumer to recover funds. If the address was not supplied by a consumer or merchant directly, another challenge the system faces is determining the correct address to send the reward to in the case of multiple payment transactions. Multiple transactions for a single payment may be a sign of scammers trying to confuse the system in order to receive the rewards. This includes scammers sending an insignificant amount of cryptocurrency to the address used for processing the payment in order to be identified as an address that can receive the rewards. In one embodiment, the tokenback address oracle 39A uses the address from which the oldest known transaction came for the PPT request. In another embodiment the reward is split according to the payment amounts for each of the transactions, possibly ignoring transactions below a threshold value, which are normally associated with scammers. In another embodiment, especially if the reward value is low compared to the amount paid, the system can use the source address of the transaction with the biggest amount paid.

In step 120, the tokenback reward distributor 39D sends the cryptocurrency reward to the consumer wallet address after a threshold time. (See also step 364 in FIG. 4A discussed below).

In one embodiment, the form of the reward varies. The token may be sent to the consumer's wallet address in the form of the token paid, in another token on the same blockchain, or in another cryptocurrency or token that is hosted on a different blockchain. The wallet to which the payment is sent can also vary. The reward may be sent automatically to the wallet from which the payment was made, sent to a wallet provided by the consumer in a widget, sent to a wallet provided by API by the merchant, or when sending to a different blockchain, should the wallet or blockchain protocol be able to handle multiple cryptocurrencies, the reward is sent automatically to the wallet from which the payment was made. In other embodiments, the reward is sent in fiat to the consumer's bank account or digital account (CashApp, Venmo, GooglePay, ApplePay), sent in the form of a coupon or gift card through email, SMS, mail, or in person at the merchant's retail store. In an embodiment, the reward takes the form of a discount applied to the PPT that reduces the total amount the consumer has to pay the merchant based on the calculated reward. In such an embodiment, the reward is calculated in step 210 of FIG. 3 and the discount is then applied in step 218 before the payment transaction starts. Thus, the consumer saves on transaction fees (or “gas” fees) while being incentivized to use cryptocurrencies for payment. In other embodiments, the reward is automatically applied to the consumer's account in a merchant's payment or reward application.

FIGS. 3-7 illustrate the operation of the digital currency payment processing platform 30 in connection with the components of the overall system 10, according to several embodiments of the present disclosure. In these embodiments, the payor is a consumer or customer 14 of the merchant 12 that interacts with the merchant system 16 through a consumer device 18 via an online interface provided by one or more servers on the merchant system 16. In another embodiment, the consumer 14 interacts with the merchant system 16 through a merchant device (not shown) similarly provided via an online interface provided by one or more servers on the merchant system 16. The digital currency used for payment by the consumer 14 can be a cryptocurrency or digital currency, and the distributed ledger 24 refers to a blockchain designed for the selected cryptocurrency. The blockchain acts as a decentralized public database, having a record of all transactions involving the selected cryptocurrency across a network of computers. It will be recognized by persons of skill in the art, however, that other forms of digital currency, tokens, and distributed ledgers may be used in accordance with the systems and methods described herein.

FIG. 3 illustrates a portion of the operation of the digital currency payment processing platform 30 in connection with the components of the overall system 10, in accordance with an embodiment of the present disclosure. Specifically, FIG. 3 shows the determination of whether a PPT request is eligible for a tokenback reward and an amount of such a reward.

As noted above, prior to initiating payment a consumer 14 uses the consumer device 18 to interact with a merchant system 16 to browse various goods and services (including, but not limited to, other cryptocurrency assets) available for purchase by the merchant and select them for purchase. As noted above, in one embodiment the merchant's goods and services are browsed via a merchant's online webstore through any network-connected consumer device. For example, the merchant system 16 has one or more servers that host an online interface, and the consumer 14 uses a web browser or other application on the consumer device 18 to communicate with the merchant server system 16, to navigate the online interface provided by the merchant system 16 to build a cart of goods and services that the consumer desires to purchase, and then to “checkout” and proceed with the transaction to pay for those goods or services with the option of using a digital currency wallet (which may be located on the same consumer device 18 or another consumer device) to provide the digital currency payment for the transaction. The merchant's goods and services can also be identified and selected for purchase in a brick-and-mortar store through the assistance of a sales associate or cashier using a POS system to identify the goods and services selected for purchase by the consumer (such as, for example, by scanning such items). In other embodiments, the merchant may provide at the brick-and-mortar location a kiosk or customer-facing POS that allows the consumer to self-select the goods and services for purchase. The merchant system 16 then determines the total amount to be charged, or invoiced, for the goods and services selected in a given fiat currency, including any applicable taxes, fees, or delivery costs, and displays this amount for viewing by the consumer via an interface. In addition, the merchant system 16 provides the consumer 14 with options for paying the amount to be charged, including an option to pay via one or more digital currencies or cryptocurrencies as an alternative to, or in addition to, fiat currency. In one embodiment, the interface of the merchant system 16 displays the total amount to be charged in a given fiat currency, such as USD, and also displays an option to pay the amount in fiat currency along with an option to pay via digital currencies, including a list of digital currencies and cryptocurrencies accepted by the merchant for payment. The list of available digital currencies and cryptocurrencies that can be used for payment are provided to the merchant system 16 by the payment processing platform 30.

Referring to FIG. 3, in step 202 a consumer opts to pay with digital currency in the form of cryptocurrency using the merchant system 16. In step 204, the PPT request is initiated and a cryptocurrency rate and amount are obtained on the merchant system. In step 206, the PPT request is received by the payment processing system 30, and a market value of the selected cryptocurrency for the PPT request is determined. In step 208, the payment processing system 30 determines if the PPT is eligible for tokenback rewards. In one embodiment, step 208 includes determining the reward amount, for example 5% of payment. Determining the reward amount includes taking into account the cost of transmitting the reward to the consumer wallet (e.g., transaction fees, network fees, or gas fees, and the like) and if there are any rewards left after such fees. In another embodiment, the cost of transmitting the reward to the consumer wallet can instead be paid by the payment processing system 30 or merchant system 16. In step 210, the tokenback eligibility checker 39B determines the amount of tokenback rewards the PPT request may receive. In step 212, the tokenback pool handler 39C determines whether the reward pool has sufficient tokens for the tokenback reward amount. In step 214, the tokenback reward distributor 39D assigns tokenback rewards to the PPT request in accordance with the form and amount of the reward. In step 216, the payment processing system 30 returns the determined cryptocurrency rate and amount and the amount of tokenback rewards for the PPT request. In step 218, the merchant system 16 displays to the customer the cryptocurrency rate and amount to the customer and the reward details for the PPT request. In step 220, the merchant system 16 starts the payment transaction. In step 222, the payment processing system 30 locks the cryptocurrency rate and amount for the transaction. In step 224, the payment processing system 30 generates a wallet address for receiving the cryptocurrency payment. In an embodiment, a wallet address is generated for each PPT request. Depending on the particular embodiment and the specifics of the PPT, reward eligibility conditions, reward characteristics, and characteristics of the address for receiving the reward, the process continues to step 330, 430, or 530 in FIGS. 4A, 5A, or 6A, respectively.

FIG. 4A illustrates a portion of the operation of the digital currency payment processing platform 30 in connection with the components of the overall system 10, in accordance with an embodiment of the present disclosure. FIG. 4B illustrates an additional portion of the operation of FIG. 4A. Specifically FIGS. 4A and 4B shows the determination of wallet address to receive the tokenback reward.

In an embodiment, the payment may be received on the generated wallet address from two or more sources or through two or more transactions. This may be due to the customer using multiple wallet addresses to send the payment for the PPT request, such as in response to an underpayment scenario resulting from variations in the value of a cryptocurrency or token used to submit payment. However, multiple transactions to the generated wallet address for payment may also be based on a third party sending the cryptocurrency to the generated wallet address on accident or with malicious intent such as with the intent of scamming the system for the reward.

FIG. 4A includes continuing the operation the digital currency payment processing platform 30 of FIG. 3. Step 330 continues from step 224 in FIG. 3 and the merchant system 16 displays the cryptocurrency amount, generated wallet address to the consumer and reward details for the payment processing transaction (PPT) request. In one or more embodiments, a consumer is shown, through a display on the consumer device 18 or personal device (not shown), the cryptocurrency amount, an exchange rate, a reward percentage, a reward estimate amount, and a prompt or field to enter the consumer's wallet address for receiving the reward.

In step 332 the consumer device 18 receives the generated cryptocurrency wallet address and the payment amount from the merchant system 16. In one embodiment, the consumer receives this information, for example, by scanning a QR code, deep link, or various alternative methods. In step 334, the consumer sends the cryptocurrency payment to be recorded on the distributed ledger. In step 336, the payment transaction is accepted or recorded on the distributed ledger. In step 338, which can occur at the same time as step 332, 334, or 336, the payment processing system monitors the distributed ledger transactions for the PPT. For example, the payment processing system monitors the generated wallet address for the PPT request to determine if a transaction is recorded on the distributed ledger. In step 340, the payment processing system determines that a ledger transaction exist with regard to the generated wallet address and continue to step 342 if there is and go back to step 338 if there is not. In step 342, the payment processing system determines that at least two wallet addresses associated with the ledger transactions exist. In step 344, the payment processing system confirms that the transactions for the payment amount for the PPT by the at least two wallet addresses are recorded. In step 346, the tokenback address oracle 39A determines a first wallet address associated with the ledger transaction is to be used for sending tokenback rewards to the consumer.

As discussed above, it is important to correctly determine the wallet address for sending the tokenback rewards, and there are multiple ways to determine the correct address, as described above. Users with malicious intent such as scammers could try to confuse the system by mimicking payment transactions (most likely, but not necessarily, with lower amounts) in an effort to gain the reward. This includes scammers monitoring blockchain transactions to determine which new payment address is used for a reward-applicable payment and then sending a small payment to that payment address in the hope that the reward would be paid to them instead of to the actual payer. Such users may monitor blockchain transactions to determine new payment addresses that may be used for a reward-eligible payment, and may attempt to send a small payment to the payment address to mimic the reward payment while attempting to intercept or redirect the larger reward payment to themselves. Other users with malicious intent, such as competitors to the merchant or payment processors could attempt to reroute rewards to never reach eligible consumers, as described above with regard to sending small payments to the payment address, thus creating support problems and possibly credibility issues for the merchant and payment processor. Splitting the reward proportionally according to the payment amounts that come from more than one address helps if an attacker's motivation is gaining the reward, but leads to incomplete reward payments to legitimate consumers. It is also possible to take the transaction with the biggest amount to be the one eligible for the reward. Using the first transaction as the one eligible for the reward also avoids most of the problems, as discussed above. Alternatively, it's possible to split the reward and send it to the various wallet addresses used to provide payment, with the amount of the reward payment going to each wallet address being in proportion of the payment received from that wallet address.

Assuming the involved parties (consumer, merchant and payment processor) are the only ones that know the payment processing transaction (PPT) address, the scammer can still mimic the transaction, however this has no effect on the reward if the original transaction was already confirmed in the blockchain.

After step 346, the process proceeds to steps 348 and 352 (see FIG. 4B). In another embodiment, the process can include step 446 or step 546 in FIGS. 5A and 6A, respectively. In step 348, the payment processing system sends a webhook notification to the merchant system. In step 350, the merchant system checks the payment details.

In step 352, the payment processing system returns payment details to the merchant system. In step 354, the merchant system receives payment details from the payment processing system. In step 356, the merchant system confirms the payment. In step 358, the consumer device receives an invoice from the merchant system. In an embodiment, the invoice is displayed or printed in a receipt to the consumer. In step 360, the payment processing system checks if the tokenback reward pool has enough rewards left for the tokenback reward assigned to this PPT request and, if there is, it continues to step 364; if not, the system continues to step 362. In step 362, the payment processing system waits for the next tokenback pool and adds the current reward to the queue when it becomes available. In step 364, the payment processing system adds the tokenback reward to the queue to be sent to the payor or customer's wallet address after a threshold period of time, such as 24 hours, by using the first wallet address associated with the transaction. In another embodiment, the tokenback reward is sent after a different threshold period of time, for example, 48 hours. In step 366, the payment processing system sends the tokenback reward transaction into the distributed ledger for sending the reward and recording it. In step 368, the distributed ledger accepts the transaction and records it. In step 370, the consumer device notifies the consumer that the tokenback reward is available in the first wallet address used for payment.

FIG. 5A illustrates a portion of the operation of the digital currency payment processing platform 30 in connection with the components of the overall system 10, in accordance to an embodiment of the present disclosure. FIG. 5B illustrates an additional portion of the operation of FIG. 5A. Specifically FIGS. 5A and 5B show the determination of the wallet address to receive reward payment including scenario.

When the user or consumer pays from an exchange wallet address, the digital currency payment processing platform 30 is capable of determining the consumer's use of an exchange wallet address so that it can later determine the appropriate manner in which to deliver the reward to the consumer, including the proper wallet address to use as the destination for the reward payment The digital currency payment processing platform 30 can determine that the consumer is using an exchange wallet address by, for example, maintaining in the database a lookup table or other database of known exchange addresses and then comparing the consumer's wallet address to the list of known exchange addresses. Additionally or alternatively, the digital currency payment processing platform 30 can analyze the number of transactions associated with the consumer's wallet address, and determine that the wallet address is not associated with an individual, but rather with an exchange (or other non-individual entity or institutional entity), if the wallet address has a large number of transactions on wallet. For example, the digital currency payment processing platform 30 can maintain an average or maximum number of transactions associated with wallet addresses associated with individuals, and can then flag as an exchange address (or institutional address) a wallet that exceeds a threshold based on this average or on this maximum. A wallet address flagged an exchange address (or non-individual or institutional address) can be processed accordingly as further described herein in order to ensure that the reward payment is directed to an appropriate address for receipt by the consumer.

FIG. 5A continues the operation the digital currency payment processing platform 30 of FIG. 3, with step 430 continuing from step 224 in FIG. 3. At step 430 the merchant system 16 displays the cryptocurrency amount and generated wallet address to the consumer and reward details for payment processing transaction (PPT) request.

In step 432 the consumer device 18 gets the generated cryptocurrency wallet address and the payment amount from the merchant system 16. The consumer can get this information, for example, by scanning a QR code, deep link, or various alternative methods. In step 434, the consumer sends the cryptocurrency payment to be recorded on the distributed ledger. In step 436, the transaction or payment is accepted or recorded on the distributed ledger. In step 438, which can occur at the same time as step 432, 434, or 436, the payment processing system monitors the distributed ledger transactions for the PPT. For example, the payment processing system monitors the generated wallet address for the PPT request to determine if a transaction is recorded on the distributed ledger. In step 440, the payment processing system determines that a ledger transaction exist with regard to the generated wallet address and continue to step 442 if there is and go back to step 338 if there is not. In step 442, the payment processing system determines that at least two wallet addresses associated with the ledger transactions exist. In step 444, the payment processing system confirms that the transactions for the payment amount for the PPT by the at least two wallet addresses are recorded. In step 446, the payment processing system determines if wallet address is associated with exchange wallet address. In an embodiment, whether the wallet address is associated with exchange wallet address is determined based on known exchange wallet addresses or based on the number of transactions associated with exchange wallet recorded on ledger. After step 446, the process continues to steps 448 and 460 (see FIG. 5B).

In step 448, the payment processing system sends a webhook notification with notification of the exchange wallet address to the merchant system. In step 450, the merchant system checks the payment details and receive a notification of an exchange wallet address. In step 452, the payment processing system returns payment details to the merchant system. In step 454, the merchant system receives payment details from the payment processing system. In step 456, the merchant system confirms payment. In step 458, the consumer device receives an invoice and a notification of exchange wallet address used for the tokenback reward from the merchant system. In an embodiment, the invoice and notification are displayed or printed in a receipt to the consumer. In step 460, the payment processing system checks if the tokenback reward pool has enough rewards left for the tokenback reward assigned to this PPT request and if there is, the processing system continues to step 464; if not, it proceeds to step 462. In step 462, the payment processing system waits for the next tokenback pool and adds the current reward to the queue when sufficient funds in the pool become available. In step 464, the payment processing system adds the tokenback reward to the queue to be sent to the payor or customer's wallet address after a threshold amount of time by using the exchange wallet address associated with the transaction. In step 466, the payment processing system sends the tokenback reward transaction into the distributed ledger for sending the reward and recording it. In step 468, the distributed ledger accepts the transaction and records it. In step 470, the consumer device notifies the consumer that the tokenback reward is available in the exchange wallet address used for payment. The consumer may then work with the exchange associated with the exchange wallet address to retrieve the rewards.

FIG. 6A illustrates a portion of the operation of the digital currency payment processing platform 30 in connection with the components of the overall system 10, in accordance to an embodiment of the present disclosure. FIG. 6B illustrates an additional portion of the operation of FIG. 6A. Specifically FIGS. 6A and 6B show a determination of the consumer wallet address to receive reward payment, according to an embodiment. In an embodiment, the determination of the consumer wallet address to receive reward payment includes a consumer specifying a wallet address either through responding to a prompt upon completion of transaction or through the consumer claiming the reward through a QR code provided to merchant or in an email link to the consumer.

At step 530, which continues from step 224 in FIG. 3, the merchant system 16 displays the cryptocurrency amount and generated wallet address to consumer and reward details for PPT request.

In step 532 the consumer device 18 gets the generated cryptocurrency wallet address and the payment amount from the merchant system 16. The consumer can get this information, for example, by scanning a QR code, deep link, or various alternative methods. In step 534, the consumer sends the cryptocurrency payment to be recorded on the distributed ledger. In step 536, the transaction or payment is accepted or recorded on the distributed ledger. In step 538, which can occur at the same time as step 532, 534, or 536, the payment processing system monitors the distributed ledger transactions for the PPT. For example, the payment processing system monitors the generated wallet address for the PPT request to determine if a transaction is recorded on the distributed ledger. In step 540, the payment processing system determines that a ledger transaction exist with regard to the generated wallet address and continue to step 542 if there is and go back to step 538 if there is not. In step 542, the payment processing system determines there is a wallet address associated with the ledger transactions. In step 544, the payment processing system confirms the transaction for the payment amount for the PPT. In step 546, the payment processing system generates a reward info request for the consumer to access tokenback rewards. In an embodiment, the reward info request is delivered through email or prompt on the merchant or user device. The email or prompt may also have, for example, a link or QR code for accessing the rewards. In step 548, the consumer device receives the reward info request for the user or consumer to select a wallet address for receiving the reward. In an embodiment, the consumer receives the reward info request with an invoice in step 560 (described below). Steps 546 and 548 continue to steps 550 and 562 in FIG. 6B.

In step 550, the payment processing system sends a webhook notification to the merchant system. In step 552, the merchant system receives and checks payment details. In step 554, the payment processing system returns payment details with the reward information to the merchant system. In step 556, the merchant system receives payment details. In step 558, the merchant system confirms the payment. In an embodiment, the merchant system, through a display, displays the reward info to the consumer. In step 560 the consumer device receives an invoice and the reward info. In step 562, the payment processing system checks if the tokenback reward pool has enough rewards left for the tokenback reward and, if it does, the system continues to step 566; if not, then it proceeds to step 564. In step 564, the payment processing system waits for the next tokenback pool and add the rewards to the queue when it becomes available. In step 566, the payment processing system adds the tokenback reward to the queue for the reward to be sent to the user or consumer selected wallet address after a threshold time, for example, 24 hours. In step 568, the payment processing system sends the tokenback reward transaction to the distributed ledger for recording. In step 570, the distributed ledger accepts the tokenback reward transaction and record it. In step 572, the consumer device receives a notice that the tokenback reward is available in the user or consumer's selected wallet.

FIG. 7 illustrates a portion of the operation of the digital currency payment processing platform 30 in connection with the components of the overall system 10, in accordance to an embodiment of the present disclosure. Specifically, FIG. 7 shows the determination of when and how to fund payment of a reward. In an embodiment, the determination includes determining that there is sufficient funds or tokens in the reward pool. In another embodiment, the determination includes analyzing the number of rewards in queue for reward payment.

FIG. 7 continues from the operation shown in step 442 (see FIG. 5A). In step 644, the payment processing system confirms the transaction for the payment amount for the PPT request. In step 646, the payment processing system sends a webhook notification to the merchant system. In step 648, the merchant system checks the payment details. In step 650, the payment processing system returns the payment details to the merchant system. In step 652, the merchant system receives the payment details. In step 654, the merchant system confirms payment. In step 656, the consumer device receives an invoice. In step 658, the payment processing system checks if the tokenback reward pool has enough rewards left for the tokenback reward and, if it does, then the system continues to step 662; if not, then the system proceeds to step 660.

In an embodiment, step 658 includes determining if the consumer has provided a wallet address for receiving the reward and if not then prompting or notifying the consumer for the wallet address. In step 660, the payment processing system waits for the next tokenback pool and add the rewards to the queue when it is available. In step 662, the payment processing system adds the tokenback rewards to the queue to be sent to the payor or customer's wallet address after a predetermined threshold period of time, for example, 24 hours. In step 664, the payment processing system sends, after the predetermined threshold period of time (for example 24 hours), the tokenback reward transaction into the distributed ledger for recording. In an embodiment, sending the reward is delayed in order to allow the consumer to earn more rewards before sending the reward to the wallet or for the consumer to receive the reward when network, transaction, or “gas” fees are lower or more economical. In step 666, the distributed ledger accepts the transaction and record it. In step 668, the consumer device notifies the consumer that the tokenback reward is available.

As noted above, in an embodiment, the reward is part of a discount applied to the PPT that reduces the total amount the consumer has to pay the merchant based on the calculated reward. In this embodiment, the reward is calculated in step 210 of FIG. 3 and the discount is applied in step 218 before the payment transaction starts. Thus, the consumer saves on transaction fees while being incentivized to use cryptocurrencies for payment.

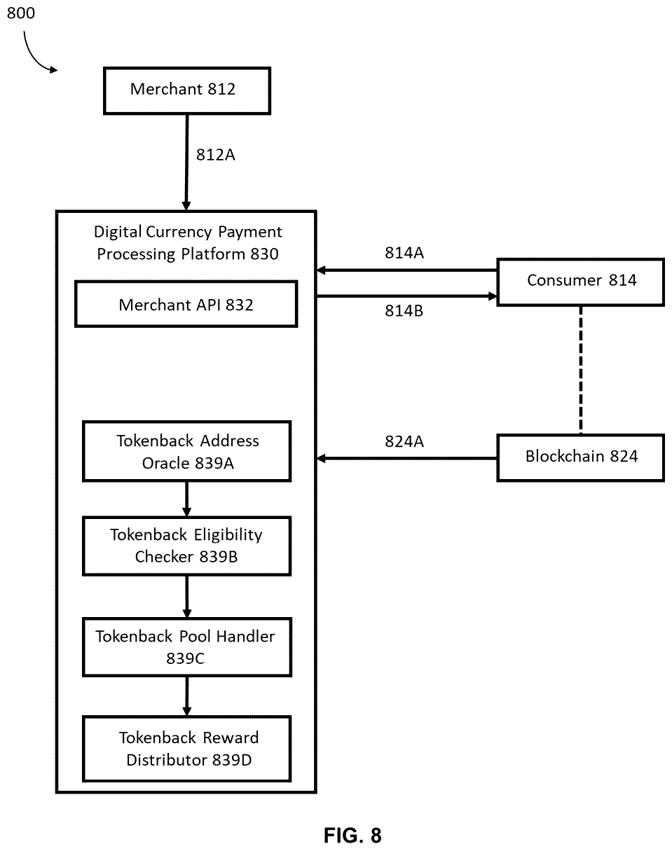

FIG. 8 shows the data flow for a PPT request in a digital currency payment processing system 800, according to an example of the present disclosure. Specifically, FIG. 8 includes the digital currency payment processing system 800 with a merchant 812, a consumer 814, a blockchain 824, and a digital currency payment processing platform 830. The digital currency payment processing platform 830 includes a merchant API 832, a tokenback address oracle 839A, tokenback eligibility checker 839B, tokenback pool handler 839C, and tokenback reward distributor 839D. The merchant 812 communicates data 812A. Data 812A includes the invoice amount and invoice fiat currency, as well as other optional data such as point of service identification, payment ID, reference number, and various automatic acceptance settings. The consumer 814 may transmit and receive data 814A and 814B, respectively, from the digital currency payment processing platform 830. The data 814A includes the cryptocurrency type. The data 814B includes payment amount and payment address. The blockchain 824 is a distributed ledger that can be viewed to determine details about a transaction including data 824A. Data 824A includes a source address. The blockchain transaction information can also include transaction identification, currency, source address, destination address, transaction amount, and transaction fee. Thus, the consumer 814 does not have to open an account or provide any non-publicly available information since all the needed data can be acquired from the blockchain. The data 812A and data 814A, and other related data are used to populate the relevant fields in the PPT Request. The tokenback address oracle 39A communicates to the tokenback eligibility checker 839B a reward address for sending the calculated reward. The tokenback eligibility checker 39B communicates to the tokenback pool handler 39C the reward address and amount for sending the reward. The tokenback pool handler 39C communicates with the tokenback reward distributor 39D the reward address, amount, and distribution date for sending the calculated reward.

Multiple embodiments are described herein, including the best mode known to the inventors for practicing the claimed invention. Of these, variations of the disclosed embodiments will become apparent to those of ordinary skill in the art upon reading the foregoing disclosure. The inventors expect skilled artisans to employ such variations as appropriate (e.g., altering or combining features or embodiments), and the inventors intend for the invention to be practiced otherwise than as specifically described herein. In addition, while the invention has been described in terms of several preferred embodiments, it should be understood that there are many alterations, permutations, and equivalents that fall within the scope of this invention. It should also be noted that there are alternative ways of implementing both the process and apparatus of the present invention. For example, steps do not necessarily need to occur in the orders shown in the accompanying figures, and may be rearranged as appropriate. It is therefore intended that the appended claim includes all such alterations, permutations, and equivalents as fall within the true spirit and scope of the present invention.

1. A computer-implemented method comprising:
receiving, via an application programming interface (API) at a payment processing system, a payment processing transaction (PPT) request to process a payment for a transaction using a cryptocurrency payment from a consumer;
determining that the request qualifies for a delivery of a cryptocurrency reward;
generating a wallet address for receiving the cryptocurrency payment;
confirming that the cryptocurrency payment is recorded in a distributed ledger based on the generated wallet address; and
issuing the cryptocurrency reward to a consumer based on the PPT request.

2. The method of claim 1, wherein issuing the cryptocurrency reward to the consumer based on the PPT request comprises:
sending the cryptocurrency reward to the consumer through the distributed ledger and based on the PPT request.

3. The method of claim 2, wherein sending the cryptocurrency reward to the consumer through the distributed ledger and based on the PPT request comprises:
determining a consumer wallet address for sending the cryptocurrency reward; and sending the cryptocurrency reward to the consumer wallet.

4. The method of claim 3, wherein determining the consumer wallet address for sending the cryptocurrency reward comprises:
determining that the consumer wallet address for sending the cryptocurrency is a wallet address recorded in the distributed ledger as making the cryptocurrency payment.

5. The method of claim 3, wherein determining the consumer wallet address for sending the cryptocurrency reward comprises:
determining that the consumer wallet address for sending the cryptocurrency is a wallet address provided by the consumer.

6. The method of claim 3, wherein determining the consumer wallet address for sending the cryptocurrency reward comprises:
determining that the consumer wallet address for sending the cryptocurrency is a wallet address provided by a merchant.

7. The method of claim 1, wherein issuing the cryptocurrency reward to the consumer based on the PPT request comprises:
applying the cryptocurrency reward to the consumer's account in a merchant's payment or reward program.

8. The method of claim 1, wherein the cryptocurrency payment comprises a first token and the cryptocurrency reward comprises a second token.

9. The method of claim 1, wherein the cryptocurrency payment comprises a first distributed ledger and the cryptocurrency reward comprises a second distributed ledger.

10. The method of claim 1, wherein issuing the cryptocurrency reward to the consumer based on the PPT request comprises:
sending the cryptocurrency reward to the consumer through a credit or debit card account.

11. The method of claim 1, wherein issuing the cryptocurrency reward to the consumer based on the PPT request comprises:
sending the cryptocurrency reward to the consumer in a form of frequent flyer miles or hotel stay credits.

12. A method comprising:
receiving, at a payment processing system, a payment processing transaction (PPT) request for a cryptocurrency payment;
determining that the PPT request qualifies for a cryptocurrency reward;
generating a wallet address for receiving the cryptocurrency payment;
confirming that the cryptocurrency payment is recorded in a distributed ledger based on the wallet address;
determining a consumer wallet address for sending the cryptocurrency reward; and
sending the cryptocurrency reward to the consumer wallet address after a threshold time.

13. The method of claim 12, further comprising:
confirming that the cryptocurrency payment is paid in full within the payment processing system wallet address based on a cryptocurrency rate and the PPT request.

14. The method of claim 12, wherein determining that the PPT request qualifies for the cryptocurrency reward comprises:
determining that the PPT request qualifies for the cryptocurrency reward based on a threshold amount of cryptocurrency paid.

15. The method of claim 12, further comprising:
determining that a reward pool has enough cryptocurrency rewards to send the cryptocurrency reward to the consumer wallet address.

16. The method of claim 12, wherein determining the consumer wallet address for sending the cryptocurrency reward comprises:
determining that the distributed ledger comprises a payment wallet address used to transmit the cryptocurrency payment;
determining that the payment wallet address is associated with an exchange wallet address based on known exchange wallet addresses; and
determining that the consumer wallet address comprises the payment wallet address for sending the cryptocurrency reward.

17. The method of claim 12, wherein determining the consumer wallet address for sending the cryptocurrency reward comprises:
determining that the distributed ledger comprises two or more payment wallet addresses used to transmit the cryptocurrency payment;
determining a first payment wallet address from the two or more payment wallet addresses based on a blockchain block number; and
determining that the consumer wallet address comprises the first payment wallet address for sending the cryptocurrency reward.

18. The method of claim 12, wherein determining the consumer wallet address for sending the cryptocurrency reward comprises:
generating a reward info request with information for accessing the cryptocurrency reward;
sending the reward info request to a consumer associated with the PPT request; and determining the consumer wallet address for sending the cryptocurrency reward to the consumer based on the reward info request.

19. The method of claim 18, wherein the reward info request comprises an email with a link for accessing the cryptocurrency reward.

20. The method of claim 19, wherein the reward info request comprises a user prompt for the consumer to enter a preferred consumer wallet address.
